(19) United States
(12) Patent Application Publication
(10) Pub. No.: US 2005/0069076 A1
(43) Pub. Date: Mar. 31, 2005

(54) Method and device for production of radio-isotopes from a target

(75) Inventors: Ray Bricault, West Boylston, MA (US); Stephane Lucas, Suarlee (BE)

Correspondence Address: MERCHANT & GOULD PC, P.O. BOX 2903, MINNEAPOLIS, MN, 55402-0903, US

(73) Assignee: ION BEAM APPLICATIONS S.A., Louvain-La-Neuve (BE)

(21) Appl. No.: 10/873,378

(22) Filed: Jun. 21, 2004

Related U.S. Application Data
(63) Continuation-in-part of application No. PCT/BE02/00198, filed on Dec. 23, 2002.

(30) Foreign Application Priority Data
Dec. 21, 2001 (EP) 01870288.6

(51) Int. Cl. G21G 1/10

(52) U.S. Cl. 376/190

(57) ABSTRACT

The invention relates to a method for production of a radio-isotope (4) from a target (3), containing a precursor (1) of said radio-isotope (4), using a beam of accelerated particles, comprising the following method steps: preparation of a target (3), containing the precursor (1) of the radioisotope (4), irradiation of said target (3) within an irradiation chamber (10) with a beam of accelerated particles in order to induce the transmutation of the precursor (1) into the radio-isotope (4), heating said target (3) in order to bring about the efflux of the radio-isotope (4) from the target (3), collection of said radio-isotope (4), extracted as a gas and condensation of said radio-isotope (4) into a solid or liquid. The invention further relates to a device for carrying out the above method and use of the device and method for the production of palladium 103 from rhodium 103.

### SUBJECT OF THE INVENTION

The present invention relates to a process and a device for producing radioisotopes from a target consisting essentially of an isotope precursor that is irradiated with an accelerated particle beam, the radioisotope being separated from its precursor once it has been produced.

One particular application of the present invention relates to the production of palladium-103 from rhodium-103.

### PRIOR ART

Radioisotopes are usually produced by bombarding or irradiating a target consisting essentially of an isotope precursor using an accelerated particle beam.

A nuclear reaction is produced therein, which causes a fraction of the isotope precursor present to be converted into a radioisotope. It should be noted that, in most cases, the radioisotope created is intimately mixed with the isotope precursor material constituting the target and consequently remains in said target.

Thereby, only a small percentage of the precursor is usually converted into usable radioisotopes.

Several types of processes have been suggested for separating the radioisotope from its precursor. One of these consists essentially of a chemical separation, according to which the target is totally dissolved, for example in a strong acid. Filtration and optionally electro-dissolution of the radioisotope are subsequently performed, and finally the radioisotope is precipitated.

This chemical separation method can be applied to the rhodium/palladium-103 couple. The target consists of rhodium, as isotope precursor, deposited on a copper support. This target is subjected to irradiation with a 14 MeV proton beam for six days, which induces a ¹⁰³Rh→¹⁰³Pd reaction and allows about 1% of the rhodium-103 to be converted into palladium-103. Once the irradiation is complete, the target is discharged and conveyed to a shielded cell called a “hot cell” in which the isotope is separated from its precursor.

The separation procedure described above is used to separate rhodium from palladium. In particular, the target consisting of the copper support and of a rhodium-palladium mixture in solid state is dissolved using a strong acidic solution such as a NH₃+H₂SO₄ mixture. This makes it possible to dissolve copper and to keep rhodium and palladium in the form of precipitates. It then suffices at this point to perform a filtration. The separation of palladium from the palladium-rhodium mixture will be obtained by electro-dissolution of the mixture in a hydrochloric acid solution with a flow of chlorine to improve the yield (Applied Radiat. Isot. 38(2), pp. 151-157 (1987)), followed by a separation step performed, for example, by complexing palladium using α-furyl dioxine (AFD) in order to selectively extract palladium via the liquid-liquid extraction method (Radiochem. Radioanal. Lett. 48(1), pp. 15-19 (1981)). A final precipitation completes the process to isolate palladium-103 from rhodium-103 and condition it in the desired state.

It is also possible to bring about a chemical dissolution of rhodium-103 in order to recover only palladium-103 using a NaAuCl₄ solution (Appl. Radiat. Isot. 48(3), pp. 327-331 (1997)) and to separate rhodium from palladium using a α-benzoinoxime (ABO) solution.

However, it is observed, firstly, that, irrespective of the separation method used, the maximum yield ever achieved described in literature is in the region of 90%.

In addition, such separation techniques are complex to implement and effluents are generated that may prove to be hazardous and polluting.

In particular, the acidic solutions used for the separation will be contaminated with radioactive waste and will require decontamination, which substantially increases the cost of the process.

Finally, unfortunately, this separation process totally destroys the target, and hence rhodium, which is a particularly expensive material. Consequently, the target cannot be reused for a further irradiation.

Lastly, to perform the final precipitation, a carrier is necessary, for example palladium-102, the use of which reduces the specific activity of palladium-103.

Document U.S. Pat. No. 5,468,355 describes in detail a process for producing ¹³N oxides, comprising a step of bombarding a carbon-based target with a beam of high-energy charged particles, so as to generate a layer of ¹³N on the surface of the target, followed by a step of combusting the target in the presence of gaseous oxygen so as to extract the ¹³N oxides from said target. Another embodiment is also mentioned in said document for extracting a radioisotope from a bombarded target, by heating said target, without combustion. According to this last embodiment, a target containing ¹⁰B or ¹⁰B as precursor is, after bombardment, heated in order to melt the boron containing compound and flushed with a gas such as helium to extract therefrom the ¹¹C radioisotope. Accordingly, said reaction cannot be defined as a dry distillation or an effusion reaction since the target is in the liquid state. Furthermore, this document does not detail the implementation of this further embodiment.

Document U.S. Pat. No. 5,987,087 describes a process for selectively extracting, by heat treatment of an arsenic-based target pre-irradiated with a beam of charged particles, the selenium-72 radioisotope produced after this irradiation. In this process, the target material, once irradiated, is mixed with a metallic reagent, such as stainless steel or aluminium filings, before undergoing a heat treatment. The production of this mixture makes it possible to obtain a differentiated sublimation of arsenic (precursor) and of selenium-72 (radioisotope of interest). The heat treatment consists in heating the target, once irradiated and then mixed with the metallic reagent, in two steps. In the first step, the mixture is heated to a temperature of between 1000° C. and 1100° C. In a second step, the mixture is subjected to a second heating at 1300° C. so as to bring about the sublimation of selenium-72, which is collected, for example, on a cold support. Selenium-72 is then recovered separately. In other words, in said document, there is an intermediate treatment step between the irradiation of the target and the heat treatment step in order to separate out the radioisotope of interest, selenium-72. The heat treatment is not performed directly on the target, but on the target mixed with a metallic reagent. The addition of said metallic reagent will also destroy the crystalline structure of the target. Furthermore, the process of said document uses a flow of a purified inert gas. Moreover, the problem that document U.S. Pat. No. 5,987,087 seeks to solve, namely that of extracting selenium-72 produced from an arsenic-based target, and the solution it proposes, relate only to a quite particular case of precursor/radioisotope.

### AIMS OF THE INVENTION

The present invention is directed towards providing a process and a device for producing radioisotopes that have not the drawbacks of the prior art.

The present invention is directed towards providing a solution that makes it possible to reduce the production of radioactive waste.

The present invention is also directed towards providing a process in which the target is not destroyed, and may thus be reused for a new production of radioisotope.

The present invention is also directed towards obtaining a radioisotope with a high specific activity.

### MAIN CHARACTERISTIC ELEMENTS OF THE INVENTION

The present invention relates to a process for producing a radioisotope of interest from a solid target comprising a precursor of said radioisotope, using an accelerated particle beam, said process comprising the following steps:
preparing said solid target comprising the precursor of the radioisotope,
irradiating, in an irradiation chamber, said target with an accelerated particle beam, in order to induce the transmutation of the precursor into the radioisotope,
heating (without the presence of oxygen) said target in order to bring about effusion of the radioisotope from the target, during said heating step, the target is maintained in a solid state,
collecting said extracted radioisotope in gaseous state and condensing said radioisotope in solid or liquid state.

It will be noted that, in the description hereinbelow, the terms “radioisotope” and “radioisotope of interest” will be used without preference to refer to the radioisotope that it is desired to produce, whereas the term “precursor” will refer to, as its name indicates, the element from which it is desired to obtain said radioisotope of interest.

In the process according to the invention, the radioisotope of interest is generally obtained by irradiation, using a proton beam of a solid target containing the precursor, the radioisotope of interest being produced in said target, preferably also in solid state.

The solid target, in the present invention, thus comprises:
before irradiation: the precursor, optionally bound to a metallic support;
after irradiation: the precursor, optionally bound to a metallic support, and the radioisotope of interest.

The separation of the radioisotope of interest and of the precursor will thus consist in subjecting the solid target to a heat treatment in order to obtain an effusion reaction, i.e. a thermal separation of the radioisotope of interest. This effusion reaction is also called dry distillation.

The heat treatment to bring about effusion of the radioisotope of interest is thus performed in the present invention directly on the irradiated target, which remains solid during the heating, rather than on a mixture consisting of the target that is irradiated and then mixed with a metallic reagent such as stainless steel or aluminium filings, in contrast with the process described in document U.S. Pat. No. 5,987,087. In other words, in the process according to the invention, it is not necessary to subject the target after irradiation to a treatment before heating it in order to extract the radioisotope of interest.

With this aim, the couples should be precursor/radioisotope of interest couples that have melting and boiling points that are relatively different from each other, such that the effusion treatment makes it possible to obtain diffusion of the radioisotope within the target itself, its extraction or escape by evaporation and sublimation, whereas the precursor of the target remains present in said target in solid state. It should thus be understood that, in the present invention, the notion of effusion refers to a physical phenomenon that is “broader” than sublimation and should be understood as comprising the phenomenon of sublimation.

More specifically, the vaporisation point of the radioisotope of interest is at least 50° C. and preferably 100° C. below the vaporisation point of the precursor.

It is also important to point out that, in the present invention, the precursor thus remains in pure state, i.e. it can be recovered at the end of the process, without it being necessary, in order to do so, to perform an additional extraction or treatment step. In other words, once the radioisotope has been extracted from the target, said target can be recovered directly without additional treatment. In the case where it is desired subsequently to reuse said precursor, this characteristic of the invention allows a certain amount of saving in time, while at the same time affording a better reutilization yield.

The heat treatment implemented to obtain effusion of the radioisotope of interest may be any treatment operating via the Joule effect.

By way of example, the energy intended for the heat treatment may originate from irradiation with a beam of charged particles such as electrons, with the beam used for the nuclear reaction, with infrared radiation, a laser treatment, a plasma treatment or any other suitable heat treatment.

Preferably, the use of a tubular heater or oven is very convenient. This is due to the fact that the heating profile of said device is very homogeneous. Furthermore, the control of the temperature inside the oven is very precise.

By way of example, heating in vacuum or under a controlled inert atmosphere will make it possible to rapidly obtain the desired effusion effect.

It should thus be understood that, in the present invention, a gas such as oxygen is not circulated during the heat treatment to which the irradiated target is subjected.

In general, there is a relationship between the rate of effusion of an element contained in a heated target and its coefficient of diffusion, since a certain number of parameters that determine the rate of effusion also have an influence on the coefficient of diffusion. Among the parameters determining the rate of effusion are:
the melting point of said element relative to the target;
the vapour pressure of the element of the diffusing element;
the activation energy of the diffusion;
the nature of the target (for example metal or ceramic); and
the size of the diffusing element, more specifically its ionic radius.

To summarize, it is found that the rate of effusion of an element (radioisotope) is proportionately greater the smaller its ionic radius: effusion from a tantalum target is thus twice as fast for beryllium as for barium. It will also be noted that the rate of effusion of an element increases exponentially as the temperature increases.

The rate of effusion of an element (radioisotope) also depends on the crystallographic structure of the target. Thus, if, during the heating of the target, recrystallization takes place, there is a reduction in the number of grain joints in the crystal and the diffusion of the element may then take place either through the joints or between the joints, which has the consequence of affecting the rate of effusion of said element.

It may be noted, finally, that the particle beam can have an influence on the rate of effusion of the radioisotope. Specifically, the rate of effusion will differ depending on the defects created by this beam in the target, between the surface of the target and the position in the target at which the radioisotope is generated by nuclear reaction. It is thus known that mechanisms referred to in the literature under the abbreviations “RED” (Radiation Enhanced Diffusion) and “RES” (Radiation Enhanced Segregation), which are associated with diffusion mechanisms (interstitial diffusion, etc.), either drastically increase the coefficient of diffusion, and thus the rate of effusion, by creating movements of holes on the diffusion path, or, in contrast, considerably reduce the diffusion by creating precipitation sites on the diffusion path.

According to a first embodiment of the present invention, the heat treatment will take place in an effusion cell that is separate from the irradiation chamber, in order to obtain said effusion.

According to a more preferred embodiment, the collection and condensation step may also be performed in said effusion cell.

With this aim, and in a particularly advantageous manner, this effusion cell will be provided with means for collecting and condensing said extracted radioisotope.

The collection and condensation means may consist of a collection substrate such as a cold or cooled ceramic, metallic or polymeric support. Preferably, this substrate will have low adhesion properties.

According to this embodiment, an additional step of separation of the extracted, collected and condensed radioisotope on the collection substrate will need to be performed. Optionally, this separation step may be performed in a separation cell that is separate from the effusion cell. Advantageously, this separation cell comprises a bath of acidic solution in which the collection substrate may be immersed in order to detach the radioisotope from said collection substrate. Next, it will be necessary to filter and separate out said radioisotope in order to condition it in the desired state.

According to another embodiment, the heat treatment may be performed directly in the irradiation chamber, for example directly by irradiating with the charged particle beam used to perform the transmutation of the radioisotope.

Another subject of the invention relates to a device for implementing the process for producing a radioisotope, said device comprising the following means:
means for irradiating a target comprising an isotope precursor, in order to induce a transmutation of the precursor into the radioisotope,
heating means to bring about the effusion of the radioisotope in said target,
means for collecting and condensing the extracted radioisotope.

Preferably, the means for collecting and condensing the extracted radioisotope consist of a cold collection substrate.

Preferably, the collection substrate has an interlayer that has properties of low adhesion with the radioisotope.

Preferably, the device according to the invention also comprises means for detaching the radioisotope from said collection substrate.

Advantageously, the detachment means consist of a separation cell comprising a bath of acidic solution in which the collection substrate with the radioisotope is placed.

The present invention also relates in particular to the use of said process and of said device for the production of palladium-103 from rhodium-103. In other words, it relates to the reaction 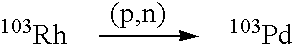
by irradiation with a proton beam.

Other examples of metal couples may, of course, be envisaged to implement the process according to the present invention.

Hereunder is a table of possible metal couples, wherein for each couple the fusion (melting point) and the vaporisation temperatures are recorded for several pressures.

| Radio- | | | | | |
|---|---|---|---|---|---|
| isotope | | T_{V} (° C.) | | | |
| couples | T_{F} (° C.) | 10⁻⁴Torr | 10⁻⁶Torr | 10⁻⁸Torr | |
| Cd | 321 | 180 | 120 | 64 | − |
| In | 157 | 742 | 597 | 487 | |
| Y | 1509 | 1157 | 973 | 830 | − |
| Zr | 1852 | 1987 | 1702 | 1477 | |
| Ta | 2996 | 2590 | 2240 | 1960 | − |
| W | 3410 | 2757 | 2407 | 2117 | |
| Rh | 1966 | 1707 | 1472 | 1277 | + |
| Pd | 1550 | 1192 | 992 | 842 | |
| Au | 1062 | 1132 | 947 | 807 | + |
| Hg | −39 | −6 | −42 | −68 | |
| Mo | 2610 | 2117 | 1822 | 1592 | + − |
| Tc | 2200 | 2090 | 1800 | 1570 | |
| Cu | 1083 | 1017 | 857 | 727 | + |
| Zn | 419 | 250 | 177 | 127 | |
| Ga | 30 | 907 | 742 | 619 | − |
| Ge | 937 | 1167 | 957 | 812 | |
| Zn | 419 | 250 | 177 | 127 | − |
| Ga | 30 | 907 | 742 | 619 | |
| Ni | 1453 | 1262 | 1072 | 927 | + |
| Cu | 1083 | 1017 | 857 | 727 | |

Only four couples have the required properties for performing a dry distillation of a solid target, namely Rh/Pd, Au/Hg, Cu/Zn and Ni/Cu.

The couple Mo/Tc could also perform an effusion or dry distillation reaction because of the small difference of the vaporisation temperature (less than 30° C.); it will be very difficult to put it in practice.

Thus Pd can be separated by effusion from a Rh target by heating said target to a temperature above 1000° C. Hg can be separated from a Au target by working with said solid target at room temperatures. Zn can be separated from a Cu target by heating the target to a temperature above 300° C. and Cu can be separated from a Ni target by heating the target to a temperature above 1050° C.

Preferably, the target should comprise a mono-isotopic precursor. However, the present invention could also be applied to targets which have no mono-isotopic precursor.

### BRIEF DESCRIPTION OF THE FIGURES

FIGS. 1a and 1b diagrammatically describe the various steps of the process for preparing the radioisotope according to a first and a second embodiment of the present invention, respectively.

FIGS. 2a and 2b respectively describe the effusion and separation cells used to implement processes according to the present invention.

FIG. 3 describes a second embodiment in which the irradiation and effusion steps are performed directly on-line in the irradiation chamber.

FIGS. 4a and 4b diagrammatically describe a particle accelerator that may be used to implement the process. FIG. 4a corresponds to a perspective view of this device, while FIG. 4b corresponds to a top view.

FIG. 5 describes an example of a tubular oven used for performing the effusion reaction according to the present invention.

### DESCRIPTION OF SEVERAL PREFERRED EMBODIMENTS OF THE INVENTION

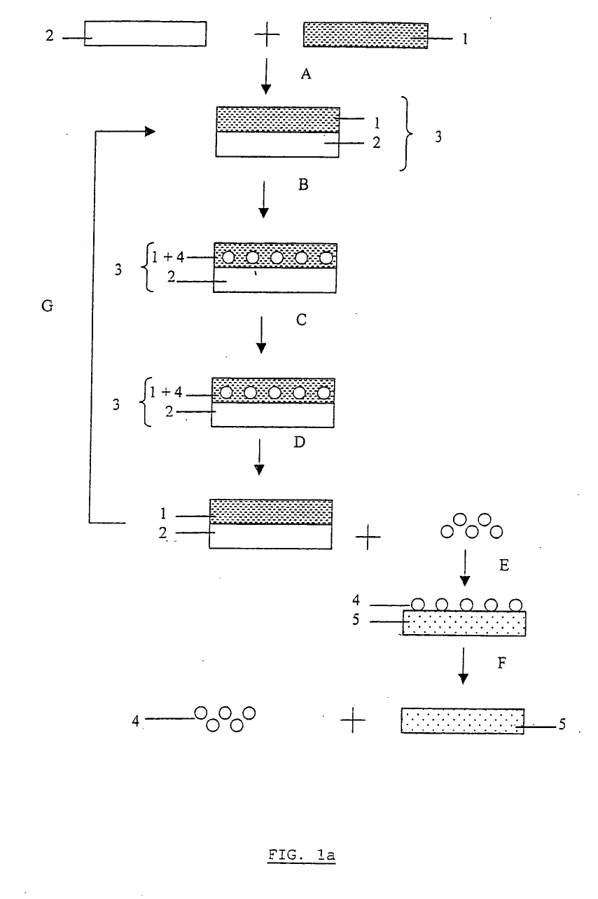

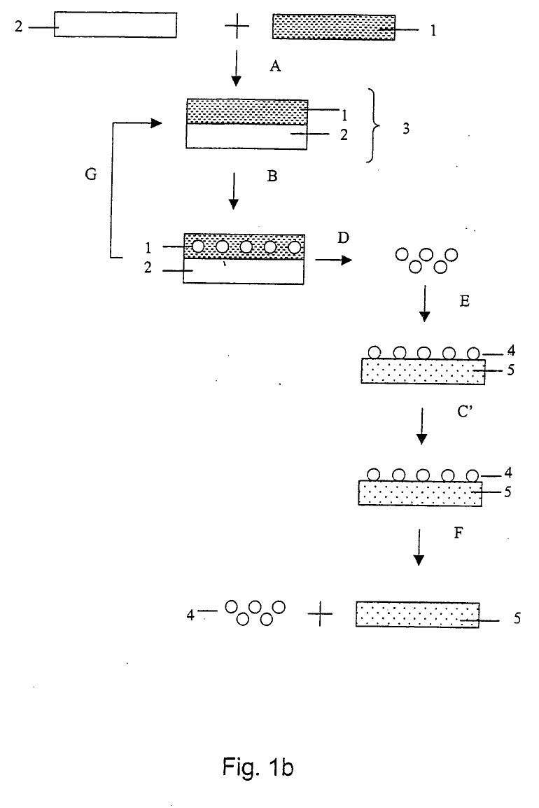

FIG. 1a diagrammatically describes the various steps of a first embodiment of the process for producing a radioisotope according to the present invention.

Reference is made to the preparation of the radioisotope ¹⁰³Pd, referenced 4, from a target 3 comprising rhodium ¹⁰³Rh, the isotope precursor, referenced 1, by irradiation with a proton beam.

At the start, it is first a matter of preparing the target 3 comprising the precursor 1 of the radioisotope 4 (step A—preparation of the target). To do this, a deposit of Rh is placed on a metal plate 2, which is, in the present case, a copper plate. This is usually performed by electrolysis, so as to obtain a deposit whose thickness is such that the proton beam used during the irradiation (for example a 14 MeV proton beam) loses at least three quarters of its energy in the target. However, other deposition techniques, for instance evaporation, and plasma deposition techniques (direct current (DC), radiofrequency or microwaves) in vacuum or atmospheric plasma (plasma spraying), may be used.

In the case of a target 3 inclined at 10° relative to the direction of the beam, a thickness of 50 μm is sufficient for 14 MeV protons.

Once target 3 has been made, it is placed in a cyclotron and subjected to a beam of protons with an energy of 14 MeV for six days (step B—irradiation).

The transmutation of ¹⁰³Rh into ¹⁰³Pd takes place at a rate of 0.225 mCi/mAH. After 144 hours, a production of 28.8 Ci will be obtained, for a DC current of 1 mA, taking the decay into account.

It should be noted that the collected amount of ¹⁰³Pd (radioisotope 4) corresponds to less than 1% of the initial amount of ¹⁰³Rh (precursor 1) present on target 3.

In this first embodiment of the invention, the temperature of the target 3 should be maintained at all times below the effusion temperature of palladium in rhodium. If this were not done, palladium would leave the target and would become condensed on the surrounding walls.

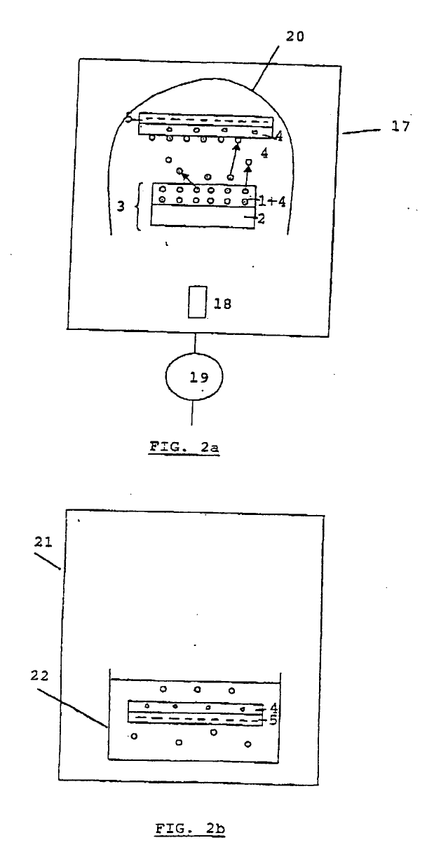

The irradiated target 3 is then discharged and transferred (step C—extraction and transfer) to an effusion cell 17 as shown in FIG. 2a. This effusion cell is a shielded cell in which the effusion (step D) is performed.

The effusion of a constituent outside an alloy (out of this alloy) is based on the following physical phenomena. The most volatile constituent (in this case palladium) passes into the gas phase, from the surface, which results in a difference in the concentration of volatile constituent between the surface and the interior of the target. A diffusion flow of the volatile constituent, from the interior of the target towards the surface, then starts. The evaporation of the volatile constituent continues, and reduces the concentration of volatile constituent in the target. Finally, the vapour of the volatile constituent is condensed and collected on a cold surface.

It will be noted that it is necessary for the volatile constituent to have a vaporisation point lower than that of the other constituents of the alloy, or a higher partial vapour pressure for a given temperature. Palladium and rhodium have vaporisation points of 1554.9° C. and 1964° C., respectively.

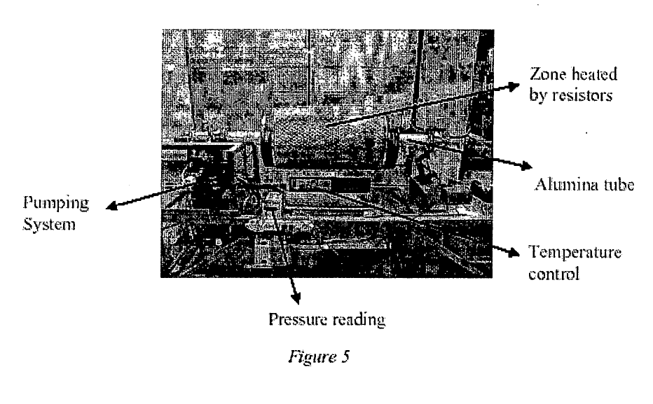

In the effusion cell 17, the target 3 is heated, for example with a tubular oven as described in FIG. 5, via the Joule effect. However, other heating means could also be applied such as induction heating means, electron beam heating means, infrared heating means, laser heating means, or DC or radiofrequency or microwave plasma means.

The next step then consists in collecting and condensing palladium 4 extracted from target 3 on a collection support 5 (step E) in order to subsequently separate it out and collect it (step F), for example in the form of PdCl₂.

FIG. 2a describes an effusion cell 17 used according to the first embodiment of the process of the invention. This is, of course, a shielded cell into which the irradiated target 3 is transferred (step C of FIG. 1a) and which allows the step of effusion (step D) of radioisotope 4 from target 3 and also the steps of uptake and condensation (step E) of said extracted radioisotope 4.

This target 3 is heated, preferably in vacuum or in a controlled atmosphere, using heat treatment means 18 so as to bring about the diffusion of palladium 4 in target 3 up to its surface and its evaporation/sublimation therefrom. A temperature between 800° C. and 1750° C. is suitable to bring about the effusion of palladium 4 out of the rhodium matrix (target 3).

Advantageously, the heat treatment means 18 are in the form of a simple electrical resistor. They should act in the shortest possible time and should be very simple to control. In addition, they should allow target 3 to be preserved and maintained intact so as to allow its subsequent use for further irradiations.

The effusion cell 17 is placed in vacuum and maintained in vacuum by means of a vacuum pump 19.

Palladium 4 present in the effusion cell 17 in gaseous state is taken up and condensed (step E of FIG. 1a) on a collection support 5. The collection support 5 is cold or cooled, at a temperature below the condensation point of palladium 4. Palladium 4 is collected in solid or liquid state.

Said substrate 5 is arranged close to the target under a protective bell jar 20.

In a particularly advantageous manner, the collection substrate 5 is a cold support made of ceramic or metal, and has poor adhesion. It may, for example, have a non-adhesive interlayer (not shown). By way of example, soluble polymers or greases may be used to make this interlayer.

After the effusion and collection operation (steps D and E), target 3 still contains virtually the initial amount of rhodium, and it has not been affected mechanically or chemically. It may thus advantageously be reinstalled in the irradiation chamber, for a new palladium production run (step G).

Next, the collection substrate 5 is transferred using a transfer system to another cell, known as the separation cell 21, in which the step of separation (step F of FIG. 1a) of the radioisotope 4 and of the collection substrate 5 is performed. FIG. 2b describes such a separation cell 21 towards which the collection substrate is conveyed.

Advantageously, this separation cell 21 comprises a bath 22 of a solution so as to release ¹⁰³Pd (radioisotope 4) into said solution. This separation may be obtained via chemical means such as dissolution of the interlayer and/or of palladium, and/or mechanical means such as stirring.

Next, this solution is treated so as to isolate ¹⁰³Pd (radioisotope 4) (step F of FIG. 1a), which is conditioned in small flasks using dose dispensers. The activity of each flask is measured for control, and the product may then be used as radiochemical product.

It should be noted that the various components of the effusion cell 17 and separation cell 21 should be such that they are easy to decontaminate, they can be integrated into a shielded cell or “hot cell”, they are equipped with a suitable system for transferring target 3, from the irradiation chamber 10 to the effusion cell 17, and from the collection substrate 5 of the effusion cell 17 to the separation cell 21, and they are easy to maintain.

The system for transferring the target 3 and the collection substrate 5 should itself be easy to disassemble, for example for the purpose of verification, and easy to decontaminate. It should also be secure.

The effusion cell 17 and separation cell 21 may be combined in the same cell.

FIG. 1b diagrammatically describes the various steps of a second embodiment of the process for producing a radioisotope according to the present invention, in which the effusion step is performed on-line, i.e. directly in the irradiation chamber.

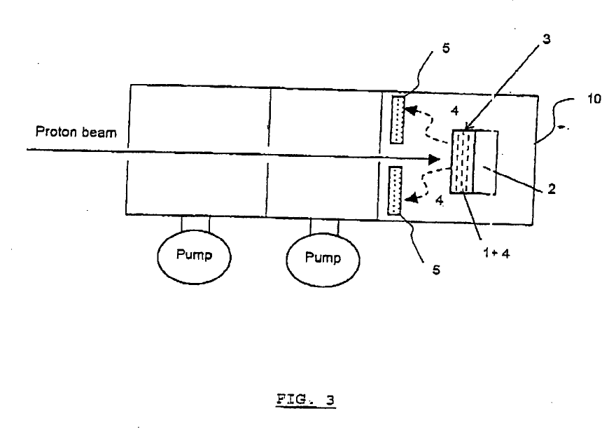

The making of the target (step A) is performed in the same manner as in the first embodiment. As shown in FIG. 3, a collection substrate 5 is installed in the irradiation chamber. It is therefore not necessary to extract target 3 in order to proceed to the effusion-collection. This device allows the irradiation and the effusion-collection to be performed simultaneously (simultaneous steps B, D and E). The energy required to heat the target is totally or partially provided by the accelerated particle beam. After irradiation, the collection substrate 5 is extracted from the irradiation chamber 10. The separation of the deposited palladium (step F) is then performed in the same manner as in the first embodiment. Target 3 can remain in the irradiation chamber 10.

FIG. 3 thus describes a device that is suitable for implementing the second embodiment of the process of the invention. The target 3 and the collection substrate 5 are installed in the irradiation chamber 10. A set of vacuum pumps makes it possible to reach in stages the high level of vacuum required in the accelerator.

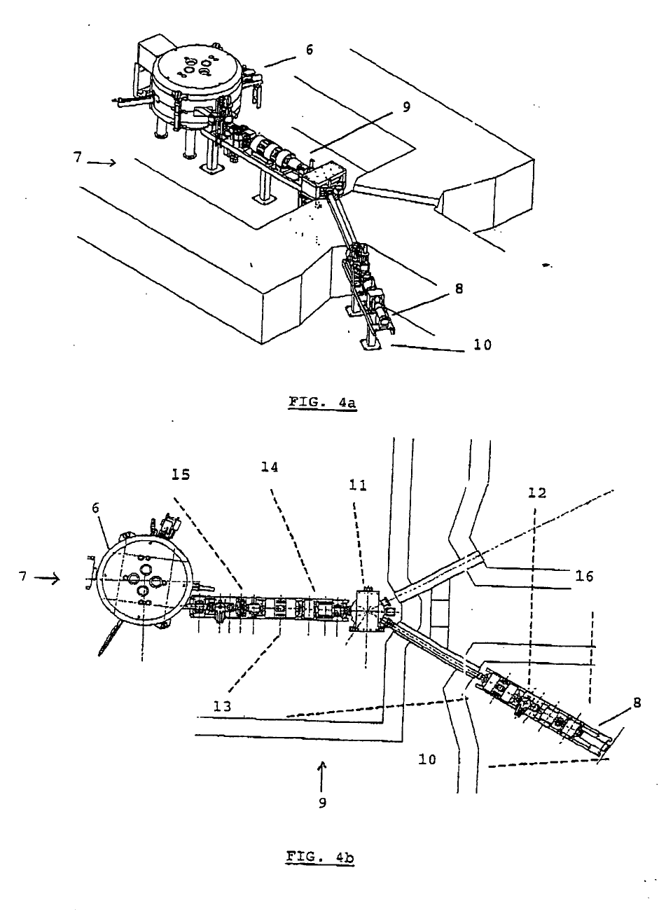

FIGS. 4a and 4b diagrammatically describe a particle accelerator that may be used to implement the process. More specifically, FIG. 4a is a perspective view of this accelerator, while FIG. 4b is a top view of this same device.

As illustrated in these figures, the particle accelerator 7 comprises:
a source capable of generating a particle beam,
the accelerator 6 itself,
a circuit 9 for conveying the beam,
a deflection magnet 11, which allows the particle beam to be directed either towards a pumping system 12 for controlling the quality of the beam parameters, or towards a shielded cell 10 constituting the irradiation chamber placed at the end of the line.

Between the accelerator 6 and the deflection magnet 11, the device 7 also comprises a series of auxiliary magnets, which correspond to quadrupoles 13 and to sextupoles 14 and whose function is to focus the beam.

It will also be noted that there are collimators 15 just at the exit of the accelerator 6.

Moreover, a sweep magnet 16 allows, as its name indicates, the target 3 to be swept using the irradiation beam.

Conventionally, the obtained target 3 is placed in the chamber 10 at the end of the beam line of the charged particle accelerator 6. Advantageously, the accelerator 6 may consist of a cyclotron, which makes it possible to generate a proton beam that has a certain divergence and that is corrected by the presence of the collimators 15.

These collimators 15 are essentially intended to prevent part of the beam (20%) from hitting components of the beam line and damaging them. Advantageously, these collimators 15 may be removable and may themselves be coated with a layer of rhodium, so as to exploit the loss of beam to produce ¹⁰³Pd (radioisotope 4) directly.

With this aim, the collimators 15 must be able to satisfy the following requirements: ease of assembly/disassembly and placement in the line, very good cooling of the irradiated surface, ease of transfer to a lead container, ease of dismantling in a hot cell, minimum mass of copper substrate, minimum surface to be coated with rhodium, reuse of a maximum of components for each irradiation.

Target 3 may also be installed directly inside the particle accelerator 6.

Both in the first and in the second embodiment of the invention, the target 3 and the collection substrate 5 may be used several times successively. This is therefore a rhodium-efficient process, which produces little waste.

The invention should not be considered as being limited to the preferred implementation examples described above. In particular, the target may entirely consist of the isotope precursor, or of an alloy comprising this isotope precursor.

1. A process for producing a radioisotope (4) from a target (3) comprising a precursor (1) of said radioisotope (4), using an accelerated particle beam, said process comprising the following steps:
preparing a target (3) comprising the precursor (1) of the radioisotope (4),
irradiating, in an irradiation chamber (10), said target (3) with an accelerated particle beam, in order to induce the transmutation of the precursor (1) into the radioisotope (4),
heating said target (3) in order to bring about the effusion of the radioisotope (4) out of the target (3),
collecting said extracted radioisotope (4) in gaseous state and condensing said radioisotope (4) in solid or liquid state.

2. The process according to claim 1, wherein the condensation of the radioisotope (4) in solid or liquid state is performed by placing the radioisotope (4) in gaseous state in contact with suitable solid means, the radioisotope (4) being separated from said means in a subsequent step.

3. The process according to claim 2, wherein it also comprises a step of conditioning said produced radioisotope (4) in a suitable liquid or solid state.

4. The process according to claim 1, wherein the heating is obtained by the Joule effect, a treatment with a beam of charged particles such as electrons, infrared radiation, a laser treatment or a plasma treatment.

5. The process according to claim 4, wherein the heating is performed in vacuum or in a controlled inert atmosphere.

6. The process according to any claim 1, wherein the heating is performed in a shielded effusion cell (17) located outside the irradiation chamber (10).

7. The process according to claim 6, wherein the collection and condensation step is performed in said effusion cell (17).

8. The process according to claim 1, wherein the steps of irradiation, heating and collection and condensation of the extracted radioisotope are performed on-line in the irradiation chamber (10).

9. The process according to claim 1, wherein, after the heating step, the target (3) is reused for a new irradiation step.

10. A device for implementing the process for producing a radioisotope (4) according to claim 1, said device comprising the following means:
means (6, 7, 8, 9, 10) for irradiating a target (3) comprising an isotope precursor (1), in order to induce a transmutation of the precursor (1) into the radioisotope (4),
heating means to bring about the effusion of the radioisotope (4) in said target,
means for collecting and condensing the extracted radioisotope.

11. The device according to claim 10, wherein the means for collecting and condensing the extracted radioisotope consist of a cold collection substrate (5).

12. The device according to claim 11, wherein the collection substrate (5) has an interlayer that has properties of low adhesion with the radioisotope (4).

13. The device according to claim 12, wherein it also comprises means for detaching the radioisotope from said collection substrate.

14. The device according to claim 13, wherein the detachment means consist of a separation cell (21) comprising a bath (22) of acidic solution in which the collection substrate (5) is placed with the radioisotope (4).

15. A use of the process for producing a radioisotope (4) from a target (3) comprising a precursor (1) of said radioisotope (4), using an accelerated particle beam, said process comprising the following steps:
preparing a target (3) comprising the precursor (1) of the radioisotope (4),
irradiating. in an irradiation chamber (10), said target (3) with an accelerated particle beam, in order to induce the transmutation of the precursor (1) into the radioisotope (4),
heating said target (3) in order to bring about the effusion of the radioisotope (4) out of the target (3),
collecting said extracted radioisotope (4) in gaseous state and condensing said radioisotope (4) in solid or liquid state or of the device according to claim 10, for the production of palladium-103 from rhodium-103.
